(19) United States
(12) Patent Application Publication
(10) Pub. No.: US 2014/0210698 A1
(43) Pub. Date: Jul. 31, 2014

(54) DRIVING METHOD FOR REDUCING EMI AND DEVICE USING THE SAME

(71) Applicant: NOVATEK Microelectronics Corp., Hsin-Chu (TW)

(72) Inventors: Ju-Lin Huang, Hsinchu County (TW); Che-Lun Hsu, Hsinchu County (TW); Yu-Shao Liu, Kaohsiung City (TW)

(73) Assignee: NOVATEK Microelectronics Corp., Hsin-Chu (TW)

(21) Appl. No.: 13/974,069

(22) Filed: Aug. 23, 2013

(30) Foreign Application Priority Data
Jan. 31, 2013 (TW) 102103802

(51) Int. Cl. G09G 3/36

(52) U.S. Cl. CPC G09G 3/3611
USPC 345/98

(57) ABSTRACT

A driving method for reducing EMI in a driving device includes detecting a voltage difference between a first display voltage and a second display voltage which correspond to the same pixel, for generating a detecting signal; and adjusting an operating method of a charge sharing switch utilized for performing charge sharing in the driving device according to the detecting signal.

### BACKGROUND OF THE INVENTION

1. Field of the Invention

The present invention relates to a driving method and related driving device for reducing electromagnetic interference (EMI), and more particularly, to a driving method and related driving device capable of adjusting an operating method of a charge sharing switch of the driving device in a display system for reducing electromagnetic interference.

2. Description of the Prior Art

A liquid crystal display (LCD) is a flat panel display which has the advantages of low radiation, light weight and low power consumption and is widely used in various information technology (IT) products, such as notebook computers, personal digital assistants (PDA), and mobile phones. An active matrix thin film transistor (TFT) LCD is the most commonly used transistor type in LCD families, and particularly in the large-size LCD family. A driving system installed in the LCD includes a timing controller, source drivers and gate drivers. The source and gate drivers respectively control data lines and scan lines, which intersect to form a cell matrix. Each intersection is a cell including crystal display molecules and a TFT. In the driving system, the gate drivers are responsible for transmitting scan signals to gates of the TFTs to turn on the TFTs on the panel. The source drivers are responsible for converting digital image data, sent by the timing controller, into analog voltage signals and outputting the voltage signals to sources of the TFTs. When a TFT receives the voltage signals, a corresponding liquid crystal molecule has a terminal whose voltage changes to equalize the drain voltage of the TFT, which thereby changes its own twist angle. The rate that light penetrates the liquid crystal molecule is changed accordingly, allowing different colors to be displayed on the panel.

If the same polarity voltage (positive voltage or negative voltage) is used to drive liquid crystal cells for a long period of time, the liquid crystal cell will eventually become polarized to a degree from which it is not able to recover. The polarization or refraction effects of the liquid crystal cell are thereby decreased which reduces the display quality. Therefore, when a source driver of the liquid crystal display drives pixels of the liquid crystal display, the source driver switches the polarity voltages across the liquid crystal cells (i.e. performs polarity inversion) in a certain frequency. In other words, the source driver alternatively uses the positive voltage and the negative voltage for driving the liquid crystal cells.

In order to decrease the power consumption of the source driver, the source driver usually adopts a charge sharing method when performing the polarity inversion. Please refer to FIG. 1, which is a schematic diagram of a conventional source driver 10. The source driver 10 comprises buffers 100, 102, switches 104, 106 and a charge sharing switch 108. The buffers 100, 102 are utilized for receiving differential signals to respectively output display voltages VD1, VD2. The switch 104 is coupled between the buffer 100 and an output end OUT1 for controlling a connection between the buffer 100 and the output end OUT1 according to a control signal VSW1, to output the display voltage VD1 to the output end OUT1 periodically. Similarly, the switch 106 is coupled between the buffer 102 and an output end OUT2 for controlling a connection between the buffer 102 and the output end OUT1 according to a control signal VSW2, to output the display voltage VD2 to the output end OUT1 periodically. The output end OUT1 and the output end OUT2 are coupled to an odd channel and an even channel of the display device, respectively, wherein the odd channel and the even channel are coupled to the same crystal cell (i.e. the same pixel). The charge sharing switch 108 is coupled between the output end OUT1 and the output end OUT2 for controlling a connection between the output end OUT1 and the output end OTU2 according to a sharing control signal VSW3, to repeatedly use charges stored in the output end OUT1 and the output end OUT2. The power consumption of the source driver 10 can therefore be reduced.

Please refer to FIG. 2A, which is a schematic diagram of related signals when the source driver 10 shown in FIG. 1 does not use the charge sharing to perform the polarity inversion. As shown in FIG. 2, the control signals SW1, SW2 instruct a conducting state and the control signal SW3 instructs a disconnecting state before a time T2. The output voltage VOUT1 of the output end OUT1 and the output voltage VOUT2 of the output end OUT2 become the display voltage VD1 and the display voltage VD2, respectively, wherein the display voltage VD1 is a positive display voltage VP and the display voltage VD2 is a negative display voltage VN. At the time T2, the control signals SW1, SW2 are switched. The buffer 100 adjusts the display voltage VD1 from the positive display voltage VP to the negative display voltage VN and the buffer 102 adjusts the display voltage VD2 from the negative display voltage VN to the positive display voltage VP, for completing the polarity inversion. The voltage variations of both the output voltage VOUT1 and the output voltage VOUT2 are both a difference between the positive display voltage VP and the negative display voltage VN.

Please refer to FIG. 2B, which is a schematic diagram of related signals when the source driver 10 shown in FIG. 1 uses the charge sharing to perform the polarity inversion. Unlike the embodiment in FIG. 2A, the sharing control signal SW3 is switched to instruct the conducting state at a time T1, for performing the charge sharing between the output end OUT1 and the output end OUT2. From the time T1 to the time T2, the output voltage VOUT1 and the output voltage VOUT2 gradually approach an average voltage VAVG of the positive display voltage VP and the negative display voltage VN. When the output voltage VOUT1 is adjusted to the negative voltage VN and the output voltage VOUT2 is adjusted to the positive voltage VP at the time T2, the voltage variations of both the output voltage VOUT1 and the output voltage VOUT2 are smaller than the difference between the positive display voltage VP and the negative display voltage VN. The power consumption of the source driver 10 using the charge sharing can therefore be reduced.

The resistance of the charge sharing switch 108 is designed as a predetermined value and the predetermined value is as small as possible for rapidly completing the charge sharing, so as to increase the efficiency of reusing charges. The resistance of the charge sharing switch 108 will become smaller, however, as the current passing through the charge sharing switch 108 becomes greater and the electromagnetic interference of the source driver 10 is more significant. This significant electromagnetic interference sharply decreases the performances of other circuitry and other signal lines of the display device. Therefore, there is a need for improvement over the prior art.

### SUMMARY OF THE INVENTION

The present invention discloses a driving method and related driving device for reducing electromagnetic interference that is generated when a driving device performs charge sharing.

The present invention discloses a driving method for reducing EMI in a driving device. The driving method comprises: detecting a voltage difference between a first display voltage and a second display voltage which corresponding to the same pixel, for generating a detecting signal; and adjusting an operating method of a charge sharing switch utilized for performing charge sharing in the driving device according to the detecting signal.

The present invention further discloses a driving device for a display system. The driving device comprises: a first buffer, for outputting a first display voltage; a second buffer, for outputting a second display voltage; a first switch, coupled to the first buffer and a positive output end for outputting the first display voltage to the positive output end according to a first control signal; a second switch, coupled to the second buffer and a negative output end for outputting the second display voltage to the negative output end according to a second control signal; a charge sharing switch, coupled to the positive output end and the negative output end for performing a charge sharing according to a sharing control signal; a detecting unit, coupled to the first buffer and the second buffer for detecting a voltage difference between the first display voltage and the second display voltage, to generate a detecting signal; a control unit, coupled to the detecting unit for adjusting an operating method of the charge sharing switch according to the detecting signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional source driver.

FIG. 2A and FIG. 2B are schematic diagrams of related signals when the source driver shown in FIG. 1 operates.

FIG. 3 is a schematic diagram of a driving device according to an embodiment of the present invention.

FIGS. 4A-4C are schematic diagrams of related signals when the driving device shown in FIG. 3 operates.

FIG. 5 is a schematic diagram of another driving device according to an embodiment of the present invention.

FIGS. 6A-6C are schematic diagrams of sharing control signal in the driving device shown in FIG. 3.

FIG. 7 is a flowchart of a driving method according to an embodiment of the present invention.

### DETAILED DESCRIPTION

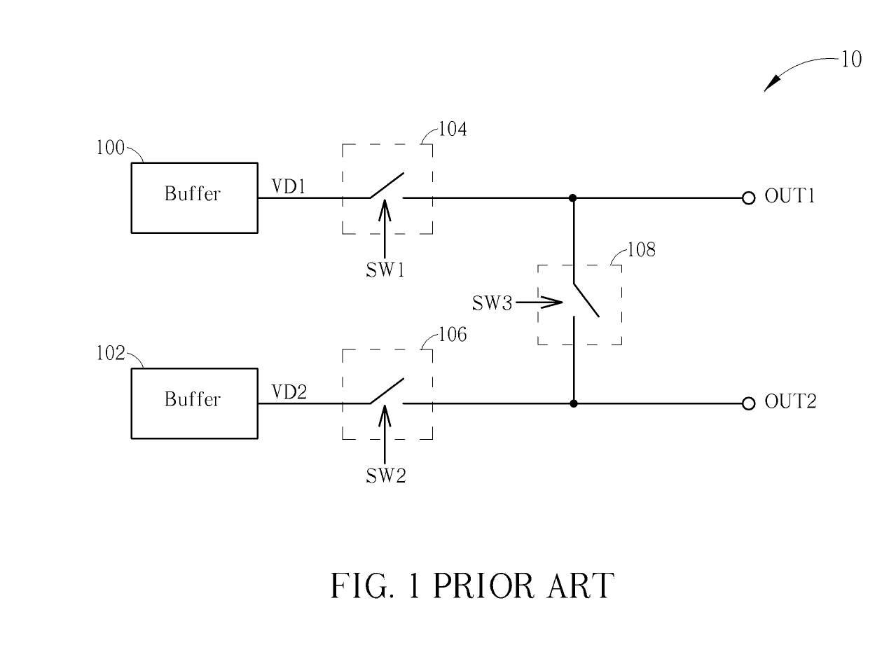

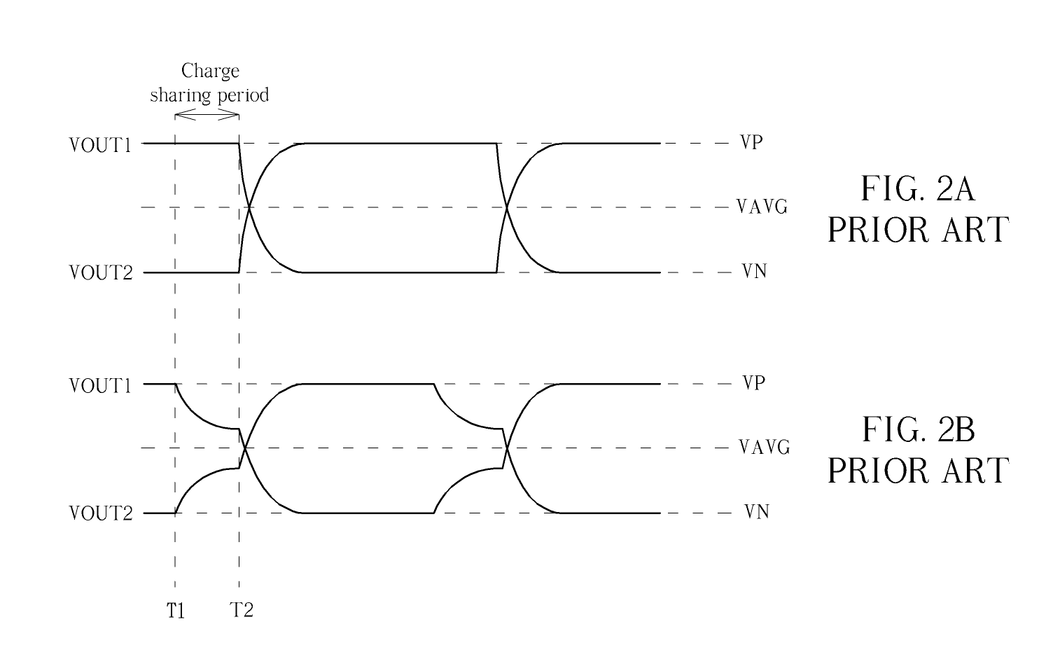

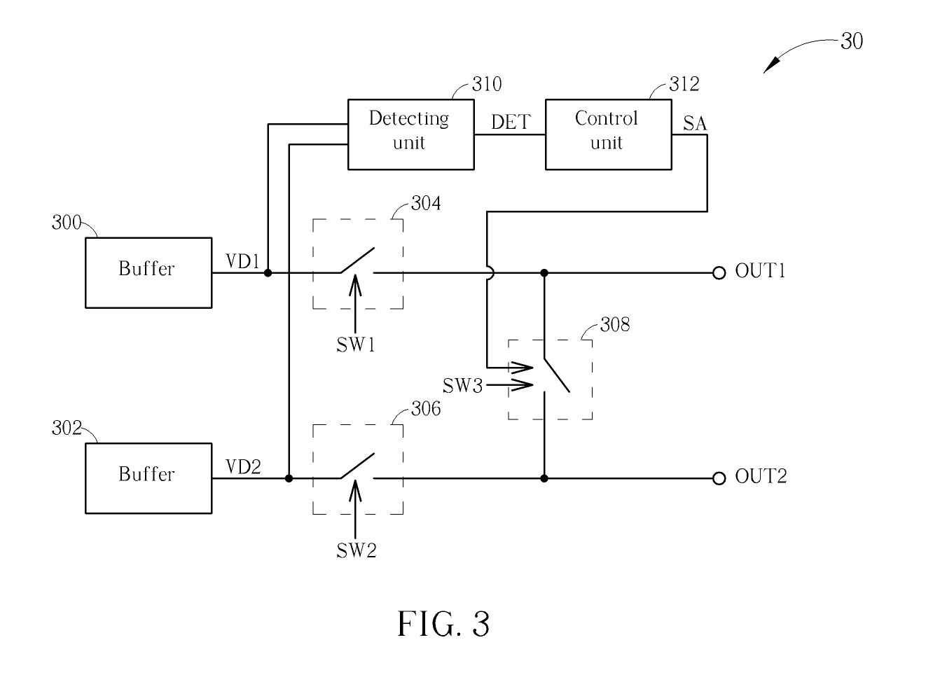

Please refer to FIG. 3, which is a schematic diagram of a driving device 30 according to an embodiment of the present invention. As shown in FIG. 3, the driving device 30 comprises buffers 300, 302, switches 304, 306, a charge sharing switch 308, a detecting unit 310 and a control unit 312. The function and the structure of the driving device 30 are similar to the source driver 10 shown in FIG. 1, thus components and signals with similar functions use the same symbol. In comparison with the source driver 10, the driving device 30 of FIG. 3 also comprises the detecting unit 310 and the control unit 312. The detecting unit 310 is coupled to the buffers 300, 302 and switches 304, 306 for detecting a voltage difference between the display voltage VD1 outputted by the buffer 300 and the display voltage VD2 outputted by the buffer 302, to generate a detecting signal DET. The control unit 312 is coupled to the detecting unit 310 for generating a sharing control signal SA according to the detecting signal DET, to adjust an operating method of the charge sharing switch 308. The driving device 30 can reduce the electromagnetic interference generated while performing the charge sharing and retain the advantage of using charge sharing to decrease the power consumption.

In detail, when a resistance R_308 of the charge sharing switch 308 is designed to be as small as possible, charges of the output end OUT1 and the output end OUT2 will rapidly be shared through the charge sharing switch 308. A charge sharing current I_308 passing through the charge sharing switch 308 will be excessively large, however, and will therefore generate significant electromagnetic interference. When a resistance R_308 of the charge sharing switch 308 is designed to be as large as possible, the speed of charge sharing between the output end OUT1 and the output end OUT2 will be too slow, resulting in an average supply current of the driving device 30 increasing. Thus, the control unit 312 adjusts the operating method of the charge sharing switch 308 according to the detecting signal DET, to make the driving device 30 completes the charge sharing around the end of charge sharing period (i.e. around the time when the charge sharing switch 308 switches from the conducting state to the disconnecting state). As a result, the charge sharing current I_308 is optimized, which can reduce the electromagnetic interference generated by the charge sharing current I_308 while retaining the advantage of decreasing the power consumption of the driving device 30 via charge sharing.

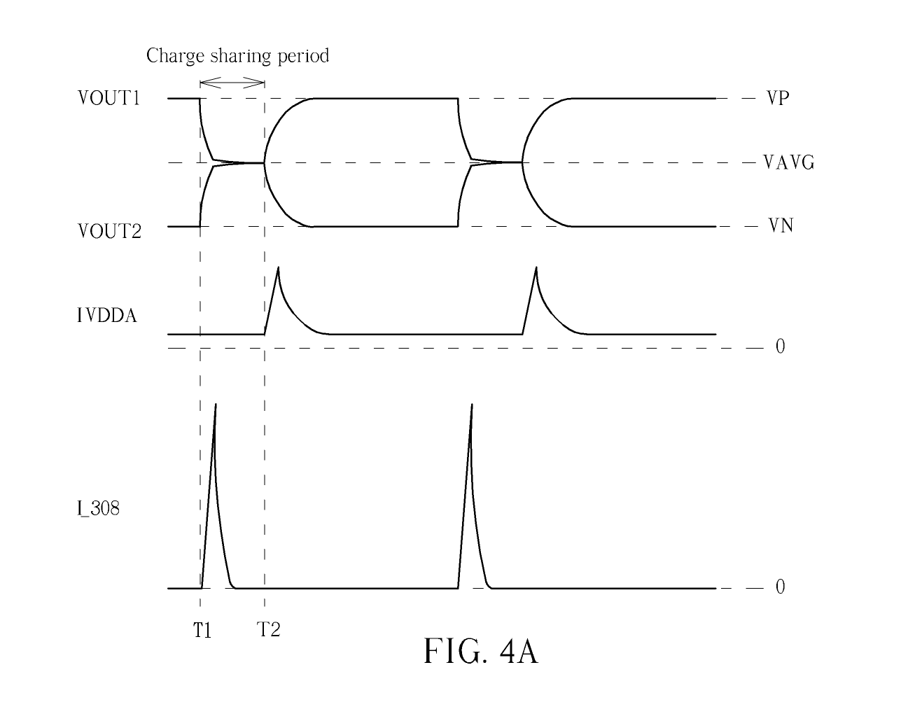

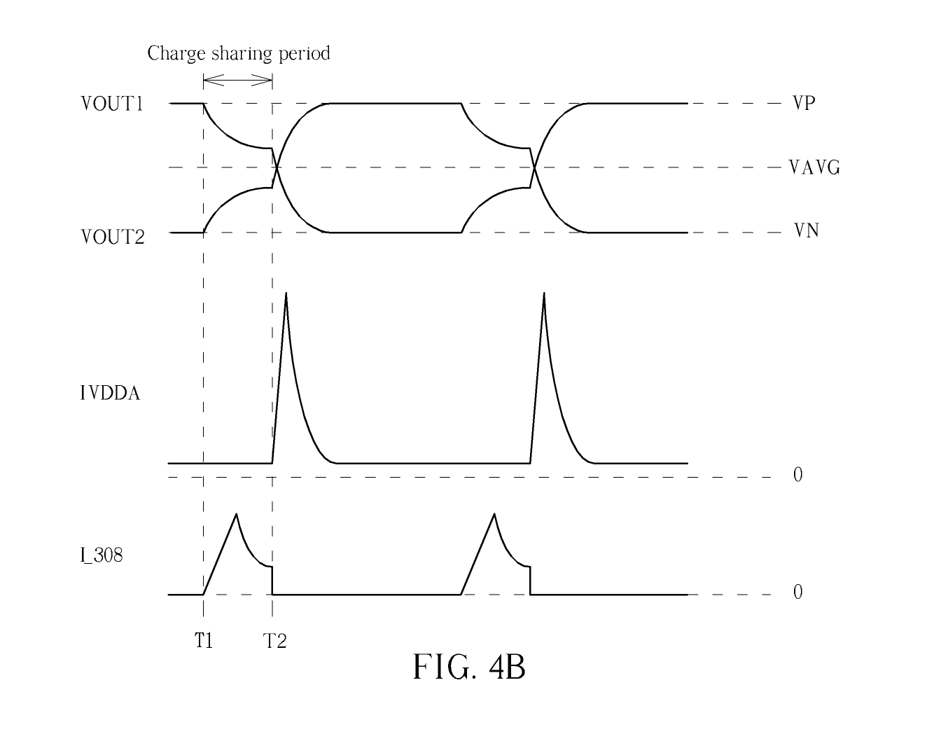

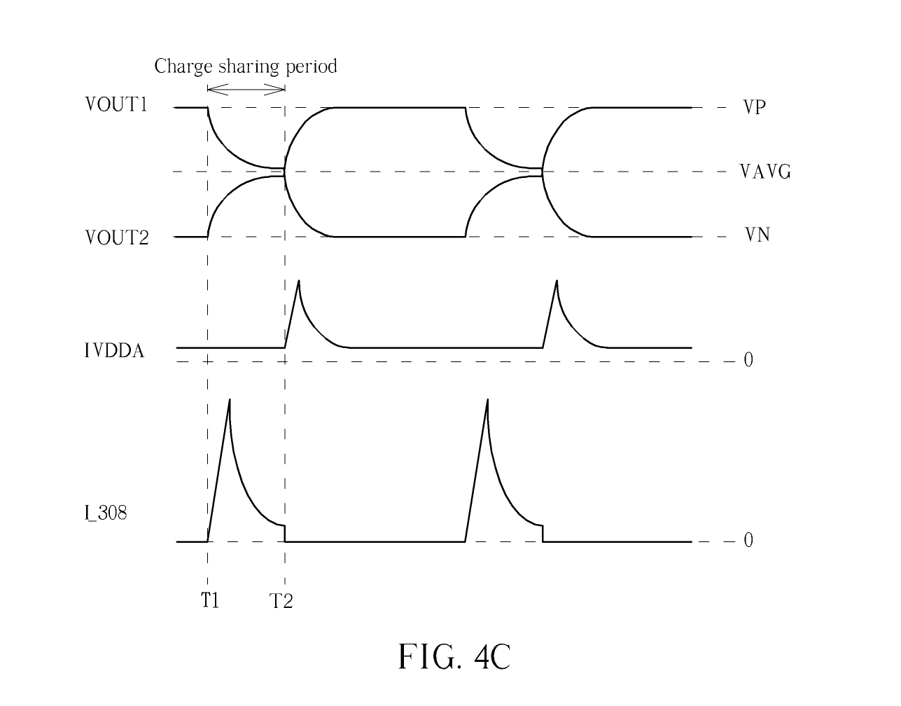

According to different applications, the method of the control unit 312 adjusting the operating method can be appropriately modified. In this embodiment, the control unit 312 adjusts the operating method of the charge sharing switch 308 via changing the resistance R_308 of the charge sharing switch 308, but is not limited herein. Please refer to FIGS. 4A-4C, which are schematic diagrams of related signals of the driving device 30 with different resistances R_308. In FIG. 4A, the resistance R_308 is designed to be a minimum value. When the switch signals SW1, SW2 and the sharing control signal SW3 are switched at the time T1, the output voltage VOUT1 of the output end OUT1 and the output voltage VOUT2 of the output end OUT2 rapidly approach an average voltage VAVG, which is the average of the positive display voltage VP and the negative display voltage VN. When the charge sharing is completed, the output voltage VOUT1 and the output voltage VOUT2 are substantially equal to the average voltage VAVG. Via the charge sharing, the glitch of the supply current IVDDA generated at the time T2 are reduced. The charge sharing current I_308 has a significant glitch at the time T1, however, resulting in large electromagnetic interference.

In FIG. 4B, the resistance R_308 is designed to be as large as possible. When the control signals SW1, SW2 and the sharing control signal SW3 are switched at the time T1, the charge sharing current I_308 generated according to the resistance R_308 is too small to allow the output voltage VOUT1 and the output voltage VOUT2 to approach the average voltage VAVG before the time T2 (i.e. the time that the sharing control signal SW3 switches to instruct the disconnecting state). The glitch of the charge sharing current I_308 generated at the time T2 can be reduced. The supply current IVDDA of the driving device 30 has a significant glitch at the time T2, however, and the power consumption of the driving device 30 thereby increases.

In FIG. 4C, the control unit 213 adjusts the resistance R_308 according to the detecting signal DET (corresponding to the voltage difference between the positive display voltage VP and the negative display voltage VN), such that the resistance R_308 becomes inversely proportional to the voltage difference between the display voltage VD1 and the display voltage VD2 (i.e. the positive display voltage VP and the negative display voltage VN). In such a condition, the charge sharing current I308 generated according to the resistance R_308 allows the output end OUT1 and the output end OUT2 to complete the charge sharing (i.e. the output voltage VOUT1 and the output voltage VOUT2 are substantially equal to the average voltage VAVG). In comparison with FIG. 4A, the glitch of the charge sharing current I_308 generated at the time T1 is reduced. Moreover, since the charge sharing is completed at the time T2, the glitch of the supply current IVDDA generated at the time T2 is minimized. In other words, the electromagnetic interference generated by the charge sharing current I_308 and the power consumption of the driving device 30 are both effectively decreased via the control unit 312 adjusting the resistance R_308 according to the detecting signal DET.

Please note that, the driving method of the above embodiments adaptively adjusts the operating method of the switch utilized for performing the charge sharing according to the adjacent output ends of the odd channel and the even channel, to allow the driving device to complete the charge sharing around the time when the switch switches from the conducting state to the disconnecting state. The electromagnetic interference and the power consumption of the driving device are therefore optimized. According to different applications, those skilled in the art may observe appropriate alternations and modifications. For example, the display system may have a plurality of driving devices, wherein the plurality of driving devices are classified into a plurality of groups. Via separating the start time and the end time of the charge sharing period of each group (i.e. the time when the charge sharing switch begins to be conductive and the time when the charge sharing switch switches to be disconnected), the peak value of the sum of the charge sharing currents in the display system can be effectively reduced. As a result, the electromagnetic interference of the display system can be further decreased according to the above concept and the driving device of the above embodiments.

According to different applications, there can be various methods of the control unit 312 adjusting the operating method. For example, when the charge sharing switch 308 of the driving device 30 is realized by an NMOS or PMOS, the control unit 312 may adjust the resistance R_308 of the charge sharing switch 308 via changing the base voltage of the charge sharing switch 308.

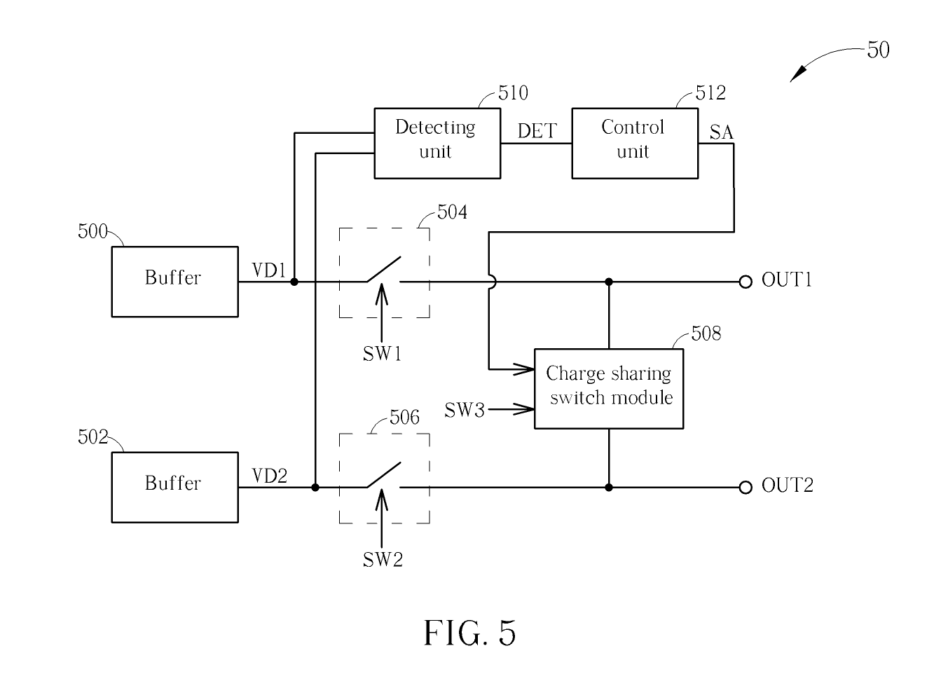

Please refer to FIG. 5, which is a schematic diagram of a driving device 50 according to an embodiment of the present invention. The driving device 50 comprises buffers 500, 502, switches 504, 506, a charge sharing switch module 508, a detecting unit 510 and a control unit 512. The function and the structure of the driving device 50 are similar to the driving device 30, thus components and signals with similar functions use the same symbol. In comparison with the driving device 30 shown in FIG. 3, the driving device 50 utilizes the charge sharing switch module 508 to replace the charge sharing switch 308. The charge sharing switch module 508 comprises charge sharing switches 508_1-508_n of different resistances. Via connecting in parallel or in series, the charge sharing switches 508_1-508_n can form a plurality of conducting paths, wherein each conducting path is different from each other. As a result, the control unit 512 can select a conducting path with an appropriate resistance according to the detecting signal DET, to allow the driving device 50 to complete the charge sharing around the end of the charge sharing period. The electromagnetic interference and the power consumption of the driving device 50 can therefore be optimized.

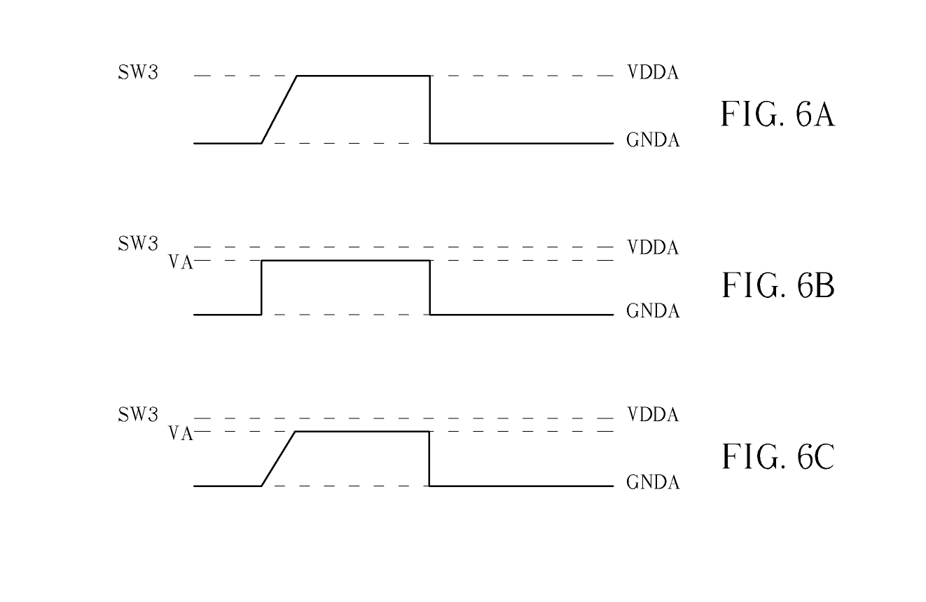

The control unit disclosed in the present invention can also adjust the resistance of the charge sharing switch via changing the sharing control signal utilized for controlling the charge sharing switch. Please refer to FIGS. 6A-6C, which are schematic diagrams of the sharing control signal SW3 shown in FIG. 3. In this embodiment, the charge sharing switch 308 controlled by the sharing control signal SW3 is realized by an NMOS. As shown in FIG. 6A, the control unit 312 adjusts the resistance R_308 of the charge sharing switch 308 via changing the time that the sharing control signal SW3 rises from the ground voltage GNDA to the supply voltage VDDA of the driving device 30. Via changing the slew rate of the sharing control signal, the control unit 312 adjusts the resistance R_308 when the charge sharing switch 308 is conductive.

In FIG. 6B, the control unit 312 adjusts the resistance R_308 of the charge sharing switch 308 via changing the maximum voltage of the sharing control signal SW3. As shown in FIG. 6B, the sharing control signal SW3 rises from the ground voltage GNDA to a voltage VA, which is lower than the supply voltage VDDA. Via changing the voltage VA, the control unit 312 adjusts the resistance R_308 when the charge sharing switch 308 is conductive. Please refer to FIG. 6C. The control unit 312 can also charge the slew rate and the maximum voltage of the sharing control signal SW3, to adjust the resistance R_308 when the charge sharing switch 308 is conductive. The operating method of the sharing control signal SW3 shown in FIG. 6C can be known by referring to the above, and is therefore not narrated herein for brevity.

When the charge sharing switch 308 of the driving device 30 shown in FIG. 3 is realized by a PMOS, the control unit 312 can also use the methods similar to those shown in FIGS. 6A-6C for adjusting the resistance R_308 of the charge sharing resistor 308. In this embodiment, the control unit 312 changes the minimum voltage of the sharing control signal SW3 to adjust the resistance R_308. For example, the control unit 312 may increase the minimum voltage of the sharing control signal SW3 from the ground voltage GNDA to a voltage VB. The resistance R_308 when the charge sharing switch 308 is conductive is accordingly changed.

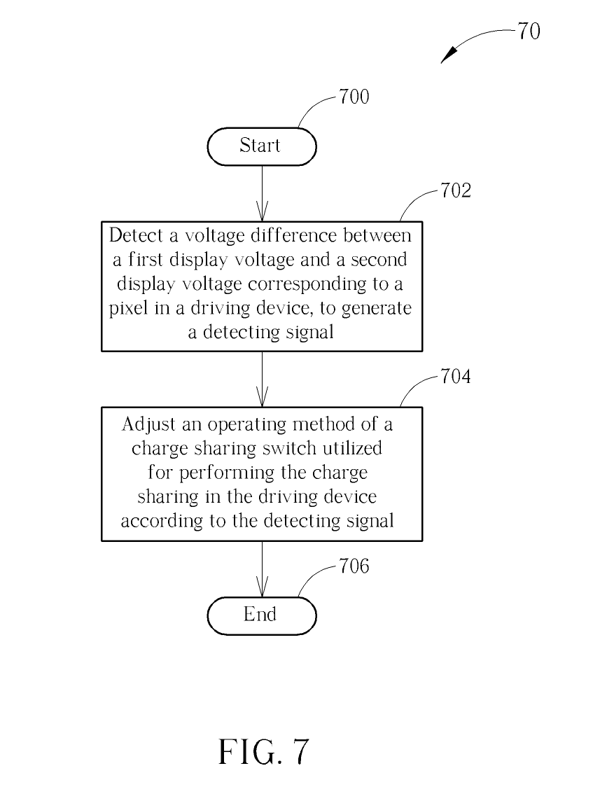

The progress of the driving device 30 shown in FIG. 3 adjusting the operating method of the charge sharing switch 308 according to the voltage difference between the positive display voltage VP and the negative display voltage VN can be summarized to a driving method 70. Please refer to FIG. 7, which is a schematic diagram of the driving method 70 according to an embodiment of the present invention. The driving method 70 comprises:

Step 700: Start.

Step 702: Detect a voltage difference between a first display voltage and a second display voltage corresponding to a pixel in a driving device, to generate a detecting signal.

Step 704: Adjust an operating method of a charge sharing switch utilized for performing the charge sharing in the driving device according to the detecting signal.

Step 706: End.

According to the driving method 70, the operating method of the charge sharing switch changes according to the voltage difference between the display voltages corresponding to the same pixel. The electromagnetic interference and the power consumption of the driving device can therefore be optimized. The details of the driving method 70 can be known by referring to the above, and are not narrated herein for brevity.

To sum up, the driving method and the driving device disclosed in the above embodiments adjust the operating method of the charge sharing switch according to the voltage difference between the display voltages corresponding to a same pixel. Accordingly, the electromagnetic interference and the power consumption of the driving device are effectively optimized.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving method for reducing EMI in a driving device, comprising:
detecting a voltage difference between a first display voltage and a second display voltage which correspond to the same pixel, for generating a detecting signal; and
adjusting an operating method of a charge sharing switch utilized for performing charge sharing in the driving device according to the detecting signal.

2. The driving method of claim 1, wherein the step of adjusting the operating method of the charge sharing switch utilized for performing charge sharing in the driving device according to the detecting signal comprises:
adjusting the charge sharing switch according to the detecting signal, for making the driving device substantially finish the charge sharing when the charge sharing switch switches from a conducting state to a disconnecting state.

3. The driving method of claim 1, wherein the step of adjusting the operating method of the charge sharing switch utilized for performing charge sharing in the driving device according to the detecting signal comprises:
adjusting a resistance of the charge sharing switch according to the detecting signal.

4. The driving method of claim 3, wherein the step of adjusting the resistance of the charge sharing switch according to the detecting signal comprises:
adjusting the resistance of the charge sharing switch according to the detecting signal, for making the resistance to be inversely proportional to the voltage difference.

5. The driving method of claim 3, wherein the step of adjusting the resistance of the charge sharing switch according to the detecting signal comprises:
adjusting a base voltage utilized for controlling the charge sharing switch according to the detecting signal.

6. The driving method of claim 3, wherein the step of adjusting the resistance of the charge sharing switch according to the detecting signal comprises:
adjusting a sharing control signal utilized for controlling the charge sharing switch according to the detecting signal.

7. The driving method of claim 6, wherein the step of adjusting the sharing control signal utilized for controlling the charge sharing switch according to the detecting signal comprises:
adjusting a slew rate of the sharing control signal according to the detecting signal.

8. The driving method of claim 6, wherein the step of adjusting the sharing control signal utilized for controlling the charge sharing switch according to the detecting signal comprises:
adjusting a maximum voltage of the sharing control signal according to the detecting signal.

9. The driving method of claim 6, wherein the step of adjusting the sharing control signal utilized for controlling the charge sharing switch according to the detecting signal comprises:
adjusting a minimum voltage of the sharing control signal according to the detecting signal.

10. A driving device for a display system, comprising:
a first buffer, for outputting a first display voltage;
a second buffer, for outputting a second display voltage;
a first switch, coupled to the first buffer and a positive output end for outputting the first display voltage to the positive output end according to a first control signal;
a second switch, coupled to the second buffer and a negative output end for outputting the second display voltage to the negative output end according to a second control signal;
a charge sharing switch, coupled to the positive output end and the negative output end for performing a charge sharing according to a sharing control signal;
a detecting unit, coupled to the first buffer and the second buffer for detecting a voltage difference between the first display voltage and the second display voltage, to generate a detecting signal; and
a control unit, coupled to the detecting unit for adjusting an operating method of the charge sharing switch according to the detecting signal.

11. The driving device of claim 10, wherein the control unit adjusts the operating method of the charge sharing switch according to the detecting signal for making the charge sharing switch finishes the charge sharing around a time when the charge sharing switch switches from a conducting state to a disconnecting state.

12. The driving device of claim 10, wherein the control unit adjusts a resistance of the charge sharing switch according to the detecting signal.

13. The driving device of claim 12, wherein the control unit adjusts the resistance of the charge sharing switch according to the detecting signal for making the resistance be inversely proportional to the voltage difference.

14. The driving device of claim 12, wherein the control unit adjusts a base voltage of the charge sharing switch according to the detecting signal.

15. The driving device of claim 12, wherein the control unit adjusts the sharing control signal according to the detecting signal.

16. The driving device of claim 15, wherein the control unit adjusts a slew rate of the sharing control signal according to the detecting signal.

17. The driving device of claim 15, wherein the control unit adjusts a maximum voltage of the sharing control signal according to the detecting signal.

18. The driving device of claim 15, wherein the control unit adjusts a minimum voltage of the sharing control signal according to the detecting signal.
